(19) United States
(12) Patent Application Publication
(10) Pub. No.: US 2016/0267172 A1
(43) Pub. Date: Sep. 15, 2016

(54) CONSTRAINT FREE MODEL

(71) Applicant: DonRiver, Inc., Dallas, TX (US)

(72) Inventors: Owain Robert Cole, Malmesbury (GB); Richard John Coles, Sutton Coldfield (GB)

(21) Appl. No.: 14/641,906

(22) Filed: Mar. 9, 2015

(51) Int. Cl. G06F 17/30

(52) U.S. Cl. CPC G06F 17/30604; G06F 17/30498; G06F 17/30371

(57) ABSTRACT

A method of and system and article of manufacture for creating a network and service inventory data model that does not constrain entities in the inventory or any relationship between entities, the method including modeling the entities, relating a first entity to a second entity via a join table, associating a label for a rule(s) and/or behavior(s) associated with an entity type of any of the modeled entities, decoupling metadata from the rule(s) and/or behavior(s), and implementing the rule(s) and/or behavior(s) associated at the entity type.

### FIELD OF THE INVENTION

The present invention relates to methods and systems for managing models as well as constraints and rules of the models and, more particularly, to managing models, constraints, and rules within telecommunication network and service inventory.

### BACKGROUND OF THE INVENTION

Within the telecommunications community, operators (“Telcos”) typically use a network and service inventory database to support their business processes, which may include network planning, network design, service fulfillment, service assurance, and so forth. For the purpose of modeling, the resulting Telco network and service inventory database may be regarded as a collection of entities. “Entities” may include, without limitation, a site, a location, a cable, a chassis, a rack, a shelf, a slot, a cross connection, an interface, a channel, a capacity, a network topology, a network device, a card, a port, a connection, a customer, a service, and any combination thereof; as well as any relationship therebetween. For example, entities that are relationships may include, without limitation connections between devices, services provided to a customer, sites containing equipment, and the like.

Conventionally, for modelling data in network and service inventory databases, some portion of the inventory may be recorded as an entity in its own right. For example, a model of a type of equipment may include a combination of various shelves and shelf types, a variety of slots and slot types, and so forth.

Although it is possible to create network and service inventory databases entity by entity and component by component, this is inefficient. Hence, templates are used conventionally to define common configurations. Specific equipment types such as an Alcatel 7750 Service Router (SR), for example, lend themselves to a template. More particularly, the Alcatel 7750 SR, which is a multiservice edge router designed for concurrent delivery of services, is known to include one (1) “shelf” of type “Main” and 12 “slots” of type “Network Card Slot,”—all of which are entities: the router, the single Main-type shelf and the 12 Network Card Slot-type slots. Thus, a template for the Alcatel 7750 SR inventory would automatically include one (1) “shelf” of type “Main” and 12 “slots” of type “Network Card Slot.”

Typically, metadata would be used as a method for defining a template, e.g., the Alcatel 7750 SR template. Such, metadata would contain information specifying that, whenever a device of type “Alcatel 7750 SR” is created, one (1) “shelf” of type “Main” and 12 “slots” of type “Network Card Slot” are also automatically created. Moreover, conventionally, metadata are embedded in the database model so that the metadata can be used to apply the same logic for any business and/or engineering constraints. As a result, it would not be possible, i.e., invalid, to have an Alcatel 7750 SR with a shelf of type “Auxiliary” or with anything but 12 slots of type “Network Card Slot.” Indeed, most inventories reject data that does not conform to the rules specified by metadata, i.e., “dirty data,” in order to keep the data within the inventory “clean.”

In business, however, for a myriad of reasons, data are generally not “clean.” For example, invalid assumptions, human error, transcription errors, bespoke of off-the-shelf solutions, “tactical” fixes, problems with recordings, and the like may produce “dirty data.” Furthermore, the metadata itself may be incorrect, requiring correction of entities conforming to the corrupted metadata that were created. In such instances, the metadata and all of the created entities must be changed simultaneously, to conform to the new, correct metadata. Such an endeavor is an expensive, time consuming, and risky process when dealing with complex network and service inventory models in Telcos.

Producing metadata for new types of entities, e.g., when introducing a new technology model to an existing network inventory system, also requires time and resources that affect overhead and the bottom line. This produces delay as the produced metadata must be thoroughly tested. As a result, it is common for businesses to have purchased and deployed a number of entities, e.g., new network equipment, before the business has signed off on the metadata for the inventory system. Consequently, a data load may also be required to ensure that these entities that were deployed before sign off are correctly populated into the inventory after deployment. Disadvantageously, if the deployed entities are not in the inventory, then the inventory cannot be used to support Telco processes such as network design, network planning, service design, and service assurance. In summary, handling “dirty” data, correcting erroneous metadata, and creating instances where metadata do not exist are problems begging for solution.

It would be desirable to provide a means for creating a network and service inventory data model that does not constrain entities or the relationship between entities. More specifically, it would be desirable to provide a means for creating a network and service inventory data model that (1) permits the existence of dirty or non-conforming data with the inventory database, allowing businesses to plan and visualize these data immediately even though there is some portion of the data that is dirty and/or non-conforming, and (2) reduces the risk and complexity of migrating data through metadata fixing or because instances were not created due to the complexities of their metadata.

### BRIEF SUMMARY OF THE INVENTION

In a first aspect, a method of creating a network and service inventory data model that does not constrain entities and does not constrain any relationship between entities is disclosed. In some embodiments, the method includes modeling each entity, to include, e.g., an identification, a name, and a type, relating a first entity to a second entity via a join table, associating a label for a rule and/or a behavior associated with an entity type, e.g., an instance, of the modeled entities, decoupling corresponding metadata from the rule and/or behavior, and implementing the rule and/or behavior associated at the entity type. In some variations, the entity is selected from the group consisting of a site, a location, a cable, a chassis, a rack, a shelf, a slot, a cross connection, an interface, a channel, a capacity, a network topology, a network device, a card, a port, a connection, a customer, a service, any combination thereof, and any relationship therebetween.

In some implementations, for a particular instance, after assessing rules, the method comprises storing a result against the particular instance as to whether or not the particular instance is conformant or not. Further implementations can include one or more of: after removing constraints from the data model, allowing data that does not conform to the rule and/or behavior associated with the entity type, allowing dirty data and/or non-conforming data to exist in the network and service inventory data model, and, when data exists for which there is no metadata, associating a label with the data with either a rule or a behavior

In some variations, the corresponding metadata are not embedded in the network and service inventory data model. In further variations, decoupling corresponding metadata includes decoupling rules regarding the metadata from the metadata itself, such that an entity can conform to the metadata without defining rules for the metadata.

In a second aspect, a system for creating a network and service inventory data model that does not constrain any entity or constrain any relationship between entities is disclosed. In some embodiments, the system includes a programmable processing device and memory for storing machine-readable instructions executable by the processing device. In some variations, when executed, the instructions cause the processing device to model each of the entities, relate a first entity to a second entity via a join table, associate a label for a rule(s) and/or behavior(s) associated with an entity type of any modeled entity, decouple corresponding metadata from the rule(s) and/or behavior(s), and implement the a rule(s) and/or behavior(s) associated at the entity type.

In a third aspect, an article of manufacture for creating a network and service inventory data model that does not constrain any entity or constrain any relationship between entities is disclosed. In some embodiments, the article of manufacture has computer-readable program portions embedded thereon and the embedded portions include instructions for causing the processing device to model each of the entities, relating a first entity to a second entity via a join table, associating a label for a rule(s) and/or behavior(s) associated with an entity type of any modeled entity, decoupling corresponding metadata from the rule(s) and/or behavior(s), and implementing the a rule(s) and/or behavior(s) associated at the entity type.

### BRIEF DESCRIPTION OF DRAWINGS

Further features, embodiments, and advantages of the present invention will become apparent from the following detailed description with reference to the drawings, wherein:

FIG. 1 shows a flow chart of an illustrative embodiments of a method of creating a network and service inventory data model in accordance with the present invention;

FIG. 2 shows an illustrative embodiment of plural entity types in accordance with the present invention;

FIG. 3 shows an illustrative embodiment of a join table for joining related entities in accordance with the present invention;

FIG. 4 shows an illustrative embodiment of associating a behavior with an entity type in accordance with the present invention;

FIG. 5 shows an illustrative embodiment of a scored entity type in accordance with the present invention; and

FIG. 6 shows an illustrative embodiment of a system for creating a network and service inventory data model in accordance with the present invention.

### DETAILED DESCRIPTION OF THE INVENTION

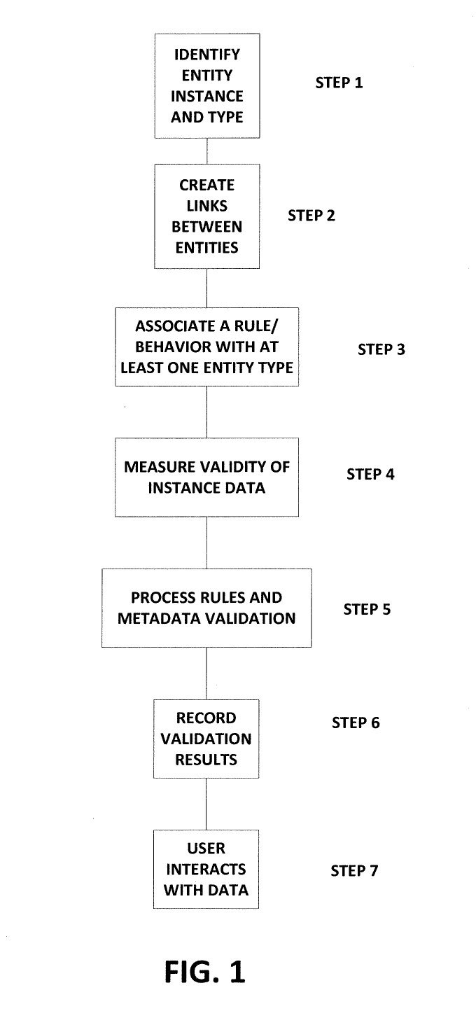

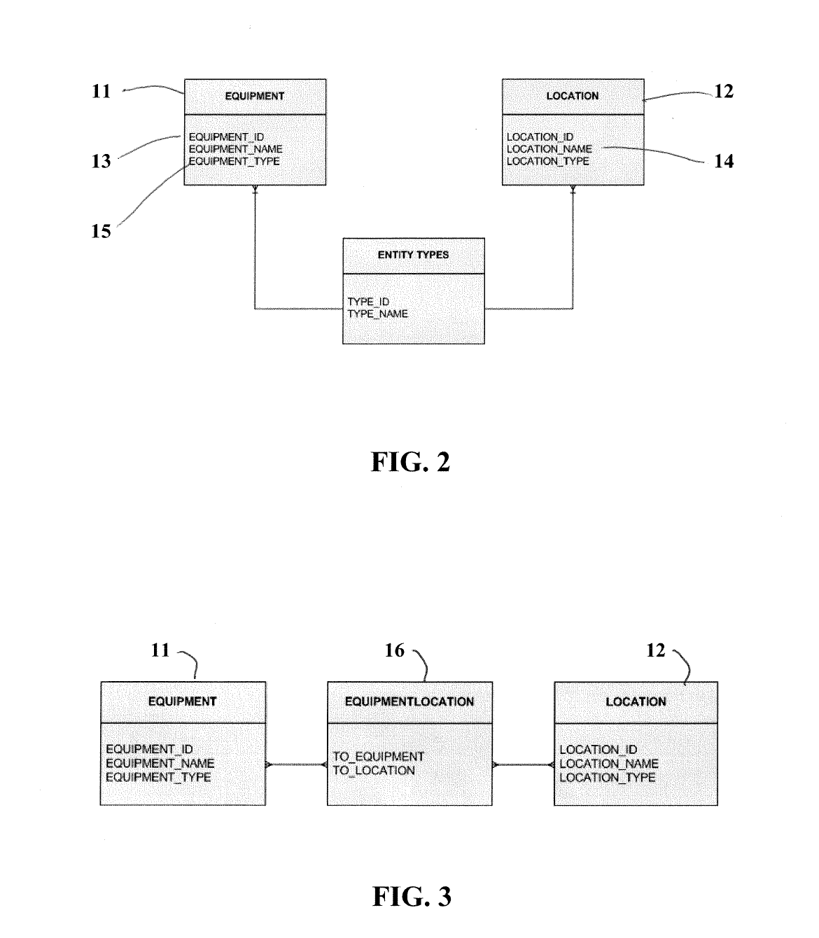

Referring to FIG. 1, a method of modeling a network and service inventory, by which relationships between entities are defined with types and, hence, a similar method of applying rules and metadata constraints, separate from the existence of the relationship itself, can be employed, is shown. Referring to FIG. 2, in database modeling, each and every entity 11, 12, e.g., a site, a location, a cable, a chassis, a rack, a shelf, a slot, a cross connection, an interface, a channel, a capacity, a network topology, a network device, a card, a port, a connection, a customer, a service, and any combination thereof; as well as any relationship therebetween, may be modeled with the following basic information: entity identification (ID) 13, entity NAME 14, and entity TYPE 15 (STEP 1). Each instance of an entity must have a TYPE, which can be a simple label such as “device,” “router,” or “unknown.” However, each TYPE can have a plurality of instances. Referring to FIG. 3, in which a first entity 11 of TYPE “Equipment” and a second entity 12 of TYPE “Location” are shown, when a relationship between the entities 11, 12 exists, in order to provide maximum flexibility to the method, a multidirectional join table 16 (EQUIPMENT_LOCATION) can be created to link the entities (STEP 2). Exemplary relationships can include, for the purpose of illustration and not limitation, a discrete piece of equipment that can be located in various instances of locations, such instances can include in a building, on a floor in the building, in a room on a floor in the building, and so forth. Advantageously, to prevent establishing instances and relationships therebetween, no constraint is enforced by default. Hence any number of instances of one TYPE can be related to any number of instances of another TYPE. Accordingly, a network device, i.e., a piece of equipment, can reside at multiple locations, e.g., room, floor, building, etc. Conversely, a location, e.g., a room, can contain multiple devices.

Metadata without rules advantageously allows zero-day planning of new types of entities. Moreover, as a result, dirty data may be represented in a network and service inventory, may be used in zero-day planning, and may be used in inventory-based Telco processes. As a result of removing constraints from the model, by moving the rules to the entity types, and by allowing data to not conform to those rules, the cost of maintenance of the network and service inventory may be reduced. In addition, rules may be applied to metadata as and when they are known. Advantageously, metadata may be updated piecemeal as required, to conform to those rules.

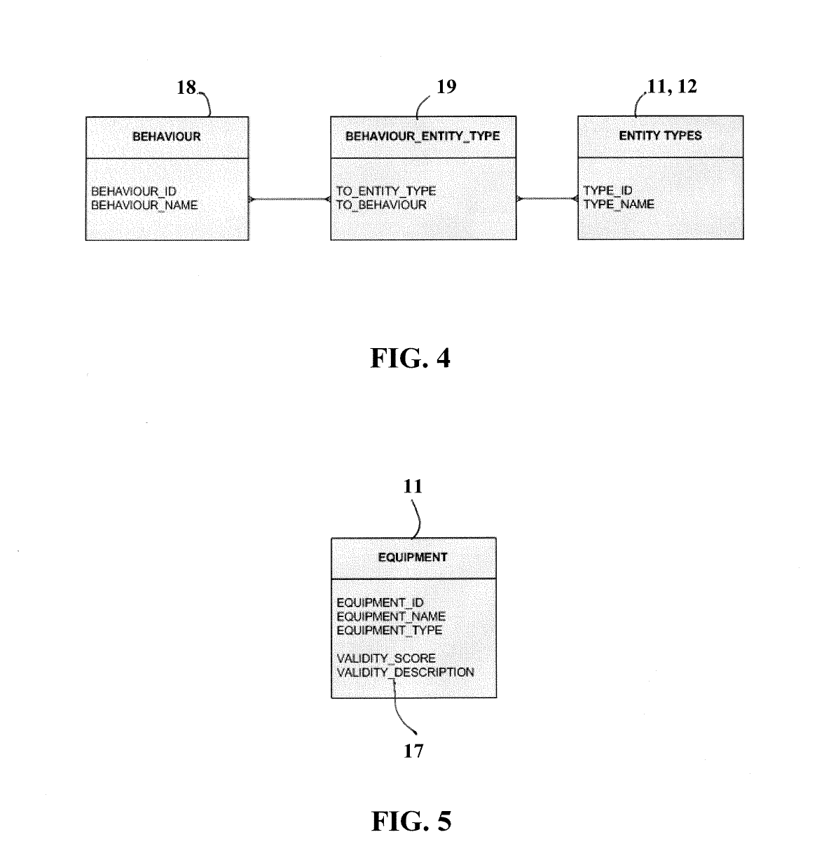

Indeed, referring to FIG. 4, in order to decouple the rule or behavior from its metadata or software implementation, the rule or behavior 18 may be associated, e.g., via an association 19, with at least one entity TYPE 11 (STEP 3). More specifically, the label 19 for a rule or behavior may be associated with the entity TYPE 11. Rules regarding the meaning of the behaviors may then be implemented, e.g., via hardware, software, and the like, using a combination of metadata and business logic. More particularly, when the rules are assessed for a particular instance, the result may be stored against the instance as an indicator as to whether or not the instance is conformant.

As shown in FIG. 5, a scoring mechanism and human readable description 17 may be stored against instances, which enable the system to measure the validity of an instance against the rule/behavior (STEP 4); process the rules and metadata validation (STEP 5); and report on the validity of an instance against the rule/behavior (STEP 6). Such an inventory allows the existence of dirty data, assesses it, and marks it as dirty. Software operating on the top of the inventory can choose to operate on the dirty data or, in the alternate, allow only read-only access to the data.

More specifically, when measuring the validity of an instance (STEPS 4 through 6), rules/behaviors may be encoded in logic using a programming language, e.g., Java. Hence, when creating entities and their relationships, the set of rules/behaviors associated with the types of the entities may be processed, i.e. tested, to determine their validity with the current applicable set of rules/behaviors for those types. Instead of rejecting the creation of entities and their relationships because of invalidity, the rules/behaviors may, instead, assign an outcome to each test. For example, some embodiments may use just two outcomes (0, 1), viz., Valid (0) and Not Valid (1), which may be recorded against the instances in the database. Other implementations may assign a score to the possible outcomes of the rules/behaviors and a ranking amongst the rules to allow a computation of overall validity, i.e., equivalent non-validity, of an entity instance to be made. This computation may also be used to record a human-readable description of the level of non-validity in the database for each instance of an entity or its relationships to other entities. Finally, in yet other implementations, the system may record a matrix of results of the rule/behavior as well as an outcome for each instance. This allows a fine-grained reporting of the state of compliance of an instance with the rules/behaviors associated with its type. Consequently, when the user interface reads the data it may also read the validity score and description, which may also be displayed to the user, e.g., using a label, coloring or other indication against the displayed details of the instance of the entities.

The validity score may also be used, e.g., by logic in a user interface, to determine what a particular user may be able to do with the data. For example, equipment entities may be validated against a rule/behavior to have 12 slots. In some variations, the validity score could be a score of zero (0) for an equipment instance having 12 slots and score of one (1) for an equipment instance with any number of slots other than 12. When displayed at the user interface, equipment instances with a validity score of 0 may be shown with a green superscript—indicating valid, clean, equipment data—and those with a score of 1 may be shown with a red superscript—indicating invalid, dirty, equipment data.

In some implementations, basic users may be prevented from making any changes or assignments to “dirty” equipment data. For example, basic users may not be allowed to add cards to its slots, connect the device to other network components, and so forth. Administrators, data quality users or other specialized users, in contrast, may be capable of overriding this restriction and of manipulating the “dirty” equipment data, e.g., to correct the data so that they are valid against the rules/behavior.

Execution of the validation process may occur whenever data are changed or read, e.g., via a scheduled batch process, or ad hoc as required.

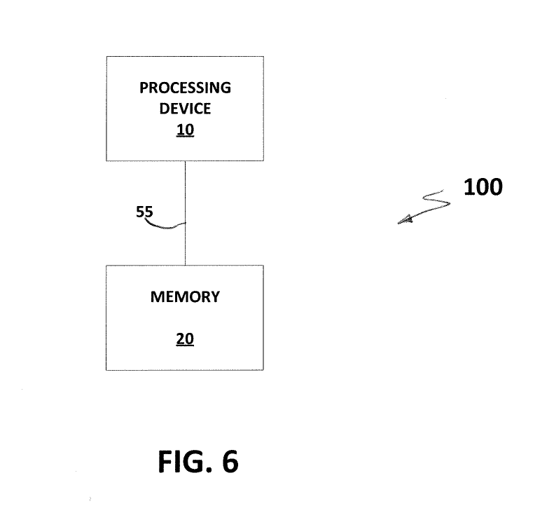

Having described a modeling method, a system 100 for modeling a network and service inventory is shown in FIG. 6. The system 100 includes a processing device 10 and a memory 20 that are in electronic communication with each other via wireless or hard-wired communication. Components of the system 100 core may be coupled by an interconnection element such as a bus 55. The bus 55 enables communications, e.g., the transfer of data and instructions, to be exchanged, e.g., wirelessly or by hardwire, internally between components and externally between system components. Thus, the bus 55 may include one or more physical busses, e.g., between components that are integrated within the system 100 core, as well as a communication coupling between system elements, e.g., specialized or standard computing bus technologies such as IDE, SCSI, PCI, and InfiniBand. In some variations, components of the system 100 core may be disposed in the same physical server and, thus, physical connectivity between the components may not be required.

The processing device 10 may include an operating system that manages at least a portion of the hardware elements included therein. Usually, a processing device or controller executes an operating system which may be, for example, a Windows-based operating system (e.g., Windows 7, Windows 2000 (Windows ME), Windows XP operating systems, and the like, available from the Microsoft Corporation), a MAC OS System X operating system available from Apple Computer, a Linux-based operating system distributions (e.g., the Enterprise Linux operating system, available from Red Hat Inc.) or a UNIX operating system available from various sources. Many other operating systems may be used, and embodiments are not limited to any particular implementation. Operating systems conventionally may be stored in memory.

The processing device 10 and the operating system together define a processing platform for which application programs in high-level programming languages may be written. These component applications may be executable, intermediate (for example, C−) or interpreted code which communicate over a communication network (for example, the Internet) using a communication protocol (for example, TCP/IP). Similarly, aspects in accordance with the present invention may be implemented using an object-oriented programming language, such as SmallTalk, Java, C++, Ada, or C# (C-Sharp). Other object-oriented programming languages may also be used. Alternatively, functional, scripting, or logical programming languages may be used. For instance, aspects of the system may be implemented using an existing commercial product, such as, for example, Database Management Systems such as SQL Server available from Microsoft of Seattle, Washington, and Oracle Database from Oracle of Redwood Shores, Calif. or integration software such as Web Sphere middleware from IBM of Armonk, N.Y.. However, a computer system running, for example, SQL Server may be able to support both aspects in accordance with the present invention and databases for sundry applications not within the scope of the invention. In one or more of the embodiments of the present invention, the processor or processing device is adapted to execute at least one application, algorithm, driver program, and the like, to receive, store, perform mathematical operations on data, and to provide and transmit the data, in their original form and/or, as the data have been manipulated by mathematical operations, to an external communication device for transmission via the network 50, 60. The applications, algorithms, driver programs, and the like that the processor or processing device may process and may execute can be stored in “memory.”

The processing device 10 may also perform functions outside the scope of the invention. In such instances, aspects of the system may be implemented using an existing commercial product, such as, for example, Database Management Systems such as SQL Server available from Microsoft of Seattle, Washington, and Oracle Database (Spatial) from Oracle of Redwood Shores, California or integration software such as Web Sphere middleware from IBM of Armonk, New York. However, a computer system running, for example, SQL Server may be able to support both aspects in accordance with the present invention and databases for sundry applications not within the scope of the invention. “Memory” may be used for storing programs and data during operation of the system 100.

“Memory” can be multiple components or elements of a data storage device 20 or, in the alternate, can be stand-alone devices. More particularly, “memory” can include volatile storage, e.g., random access memory (RAM), and/or non-volatile storage, e.g., a read-only memory (ROM). The former may be a relatively high performance, volatile, random access memory such as a dynamic random access memory (DRAM) or static memory (SRAM). Various embodiments in accordance with the present invention may organize “memory” into particularized and, in some cases, unique structures to perform the aspects and functions disclosed herein.

Those of ordinary skill in the art may realize that the invention may be embodied in other specific forms without departing from the spirit or essential characteristics thereof. The foregoing embodiments, together with the attached drawings, are, therefore, to be considered in all respects illustrative rather than limiting of the invention described herein.

What we claim is:

1. A method of creating a network and service inventory data model that does not constrain any entity of a plurality of entities and does not constrain any relationship between any of the plurality of entities, the method comprising:
modeling each of a plurality of entities;
relating a first entity to a second entity via a join table;
associating a label for at least one of a rule and a behavior associated with an entity type of at least one of the modeled entities;
decoupling corresponding metadata from the at least one of a rule and a behavior; and
implementing the at least one of a rule and a behavior associated at the entity type.

2. The method of claim 1, wherein each modeled entity of the plurality of entities includes an entity identification, an entity name, and the entity type.

3. The method of claim 2, wherein the entity type includes at least one instance.

4. The method of claim 3, wherein, for a particular instance of the at least one instance, after assessing rules, the method comprises storing a result against the particular instance as to whether or not the particular instance is conformant or not.

5. The method of claim 1, wherein an entity of the plurality of entities is selected from the group consisting of a site, a location, a cable, a chassis, a rack, a shelf, a slot, a cross connection, an interface, a channel, a capacity, a network topology, a network device, a card, a port, a connection, a customer, a service, any combination thereof, and any relationship therebetween.

6. The method of claim 1, wherein the corresponding metadata are not embedded in the network and service inventory data model.

7. The method of claim 1 further comprising, after removing constraints from the data model, allowing data that does not conform to the at least one of a rule and a behavior associated with the entity type.

8. The method of claim 1 further comprising allowing at least one of dirty data and non-conforming data to exist in the network and service inventory data model.

9. The method of claim 1, wherein decoupling corresponding metadata comprises decoupling rules regarding the metadata from the metadata itself, such that any entity of the plurality of entities can conform to the metadata without defining rules for the metadata.

10. The method of claim 1 further comprising, when data exists for which there is no metadata, associating a label with the data with either a rule or a behavior.

11. A system for creating a network and service inventory data model that does not constrain any entity of a plurality of entities and does not constrain any relationship between any of the plurality of entities, the system comprising:
a programmable processing device; and
memory for storing machine-readable instructions executable by the processing device, wherein, when executed, the instructions cause the processing device to:
model each of a plurality of entities;
relate a first entity to a second entity via a join table;
associate a label for at least one of a rule and a behavior associated with an entity type of at least one of the modeled entities;
decouple corresponding metadata from the at least one of a rule and a behavior; and
implement the at least one of a rule and a behavior associated at the entity type.

12. An article of manufacture having computer-readable program portions embedded thereon for creating a network and service inventory data model that does not constrain any entity of a plurality of entities and does not constrain any relationship between any of the plurality of entities, the embedded portions comprising instructions for:
modeling each of a plurality of entities;
relating a first entity to a second entity via a join table;
associating a label for at least one of a rule and a behavior associated with an entity type of at least one of the modeled entities;
decoupling corresponding metadata from the at least one of a rule and a behavior; and
implementing the at least one of a rule and a behavior associated at the entity type.
